(19) United States
(12) Patent Application Publication
(10) Pub. No.: US 2023/0025223 A1
(43) Pub. Date: Jan. 26, 2023

(54) R-T-B BASED PERMANENT MAGNET

(71) Applicant: TDK CORPORATION, Tokyo (JP)

(72) Inventors: Yoshinori FUJIKAWA, Tokyo (JP); Atsushi KODA, Tokyo (JP); Mika JINGU, Tokyo (JP); Takashi WATANABE, Tokyo (JP)

(73) Assignee: TDK CORPORATION, Tokyo (JP)

(21) Appl. No.: 17/779,619

(22) PCT Filed: Nov. 26, 2020
(86) PCT No.: PCT/JP2020/044025

§ 371 Date: May 25, 2022

(30) Foreign Application Priority Data
Nov. 27, 2019 (JP) 2019-214497
Nov. 27, 2019 (JP) 2019-214512
Nov. 27, 2019 (JP) 2019-214520

(51) Int. Cl. H01F 1/057; C22C 38/00

(52) U.S. Cl. CPC H01F 1/0577; C22C 38/005; C22C 38/002; C22C 2202/02

(57) ABSTRACT

An R-T-B based permanent magnet including R₂T₁₄B main phase crystal grains and a grain boundary. R represents one or more rare earth elements, T represents one or more iron group elements essentially including Fe or Fe and Co, and B represents boron. In a cross-section parallel to the alignment direction of the R-T-B based permanent magnet, the coverage of the R₂T₁₄B main phase crystal grains is 50.0% or more, and the area ratio of the R₂T₁₄B main phase crystal grains is 92.0% or more.

### TECHNICAL FIELD

The present invention relates to an R-T-B based permanent magnet.

### BACKGROUND

An R-T-B based permanent magnet is known for having excellent magnetic properties. An R-T-B based permanent magnet having further improved magnetic properties has been developed.

Patent Literature 1 describes a method of manufacturing an R-T-B based sintered magnet in which a heavy rare-earth element RH is diffused.

Patent Literature 2 describes a sintered rare-earth magnet manufactured through steps such as forming sheets from a composite material including magnet particles and a binder and then stacking the sheets and processing the stacked sheets.
Patent Literature 1: WO 2016/121790
Patent Literature 2: WO 2017/022684

### SUMMARY

However, a residual magnetic flux density of the R-T-B based sintered magnet described in Patent Literature 1 is not sufficiently high. Also, when the sintered rare-earth magnet described in Patent Literature 2 is actually manufactured, its temperature properties are not sufficient. Further, manufacturing steps are complicated, and productivity is low.

Nowadays, an R-T-B based permanent magnet having improved magnetic properties both at room temperature and at a high temperature and excellent temperature properties has been further demanded.

It is an object of the present invention to provide an R-T-B based permanent magnet having high coercivity Hcj and a high residual magnetic flux density Br at room temperature as well as excellent coercivity Hcj and excellent temperature properties at a high temperature.

To achieve the above object, an R-T-B based permanent magnet of the present invention is an R-T-B based permanent magnet comprising R₂T₁₄B main phase crystal grains and a grain boundary, wherein R is at least one rare-earth element, T is at least one iron group element comprising Fe or Fe and Co, and B is boron; and

the R₂T₁₄B main phase crystal grains have a coverage ratio of 50.0% or more, and an area proportion of the R₂T₁₄B main phase crystal grains is 92.0% or more in a cross section parallel to an orientation direction of the R-T-B based permanent magnet.

Having the above characteristics, the R-T-B based permanent magnet according to the present invention exhibits excellent magnetic properties at a wide range of temperatures.

The R-T-B based permanent magnet may further include C, and a content of C in the R-T-B based permanent magnet may be 500 ppm or less. The R-T-B based permanent magnet may further include O, and a content of O in the R-T-B based permanent magnet may be less than 900 ppm.

A residual magnetic flux density of the R-T-B based permanent magnet may be 14.0 kG or more.

A content of R in the R-T-B based permanent magnet may be 27.5 mass % or more and 31.5 mass % or less.

### BRIEF DESCRIPTION OF THE DRAWING(S)

FIG. 1 is an FE-SEM image of Example 1.

FIG. 2 is an image obtained by binarizing the FE-SEM image illustrated as FIG. 1 into R₂T₁₄B main phase crystal grains and other portions.

FIG. 3 is an image obtained by binarizing the FE-SEM image illustrated as FIG. 1 into R₆T₁₃M phases and other portions.

FIG. 4 is an image obtained by binarizing the FE-SEM image illustrated as FIG. 1 into R-OCN phases and other portions.

FIG. 5 is an image obtained by binarizing the FE-SEM image illustrated as FIG. 1 into R-rich phases and other portions.

FIG. 6 is an FE-SEM image of Example 1.

FIG. 7 is an image obtained by binarizing FIG. 6.

FIG. 8 is an image in which a portion of the main phase crystal grains in contact with a secondary phase in FIG. 7 is extracted.

FIG. 9 is an image obtained by adding a grain border to FIG. 8.

FIG. 10 is a schematic diagram illustrating a sampling region.

### DETAILED DESCRIPTION

Hereinafter, the present invention is described based on a specific embodiment.

<R-T-B Based Permanent Magnet>

An R-T-B based permanent magnet according to the present embodiment includes R₂T₁₄B main phase crystal grains and a grain boundary.

The R₂T₁₄B main phase crystal grains are main phase grains including R₂T₁₄B crystals. In a cross section parallel to an orientation direction of the R-T-B based permanent magnet, an area proportion of the R₂T₁₄B main phase crystal grains in the R-T-B based permanent magnet is 92.0% or more. Details of a method of calculating the area proportion are described later.

The grain boundary of the R-T-B based permanent magnet according to the present embodiment can be classified as a two-grain boundary in between two main phase crystal grains or a triple junction in between three or more main phase crystal grains.

In a cross section parallel to the orientation direction of the R-T-B based permanent magnet according to the present embodiment, the R₂T₁₄B main phase crystal grains in the R-T-B based permanent magnet have a coverage ratio of 50.0% or more.

In the R-T-B based permanent magnet according to the present embodiment, an area proportion of the R₂T₁₄B main phase crystal grains of 92.0% or more and a coverage ratio of the R₂T₁₄B main phase crystal grains of 50.0% or more make it easier for the R-T-B based permanent magnet to have a large volume proportion of the R₂T₁₄B main phase crystal grains and a thick two-grain boundary. Consequently, the R-T-B based permanent magnet tends to easily have a small absolute value of a temperature coefficient β of coercivity. This achieves the R-T-B based permanent magnet having excellent temperature properties of coercivity and a high residual magnetic flux density.

β is calculated using β=(ΔHcj/Hcj(T1))/ΔT, where a reference temperature is T1, a measurement temperature is T2, T2-T1 is ΔT, Hcj at the temperature T1 is Hcj(T1), Hcj at the temperature T2 is Hcj(T2), and Hcj(T2)−Hcj(T1)=ΔHcj.

Particularly, a large area proportion of the R₂T₁₄B main phase crystal grains makes it easier to increase the residual magnetic flux density. Particularly, a high coverage ratio of the R₂T₁₄B main phase crystal grains and the thick two-grain boundary make it easier to improve the temperature properties of coercivity.

In the R₂T₁₄B main phase crystal grains, a thermal expansion coefficient in a direction of an axis of easy magnetization is smaller than a thermal expansion coefficient in a direction of an axis of hard magnetization. Accordingly, at a high temperature, the R₂T₁₄B main phase crystal grains tend to easily expand thermally in the direction of the axis of hard magnetization and have a large crystal lattice strain. Consequently, an anisotropy field at a high temperature is smaller than an anisotropy field at a low temperature, which results in low coercivity. The high coverage ratio and the thick two-grain boundary make it easier to reduce the above-mentioned crystal lattice strain. This makes it easier to prevent reduction of the anisotropy field and to improve the temperature properties of coercivity.

An average thickness of two-grain boundaries is not particularly limited. The average thickness may be 5 nm or more and 50 nm or less, or may be 6 nm or more and 21 nm or less.

R is at least one rare-earth element, T is at least one iron group element comprising Fe or Fe and Co, and B is boron. The rare-earth element included as R is Sc, Y, or a lanthanide element in group 3 of the long period type periodic table. The rare-earth element R is classified as a heavy rare-earth element RL or a light rare-earth element RH. RH includes Gd, Tb, Dy, Ho, Er, Tm, Yb, or Lu. RL includes a rare-earth element other than RH. The iron group element includes Fe, Co, or Ni.

Further, a content of C included in the R-T-B based permanent magnet according to the present embodiment may be 500 ppm or less. With 500 ppm or less of C, formation of a rare-earth carbide phase at the triple junction is prevented. Thus, the two-grain boundary is easily thickened, and the coverage ratio is easily increased. Consequently, the temperature properties of the R-T-B based permanent magnet are easily improved. Note that there is no particular lower limit to the content of C included in the R-T-B based permanent magnet according to the present embodiment. For example, the content of C may be 50 ppm or more, or may be 80 ppm or more.

Further, a content of O included in the R-T-B based permanent magnet according to the present embodiment may be less than 900 ppm. With less than 900 ppm of O, formation of a rare-earth oxide phase at the triple junction is prevented. Thus, the two-grain boundary is easily thickened, and the coverage ratio is easily increased. Consequently, the temperature properties of the R-T-B based permanent magnet are easily improved. The rare-earth oxide phase does not contribute to improvement of coercivity (Hcj) at all. Accordingly, as the content of O increases, Hcj easily decreases. Note that there is no particular lower limit to the content of O. The content of O may be, for example, 200 ppm or more.

The R-T-B based permanent magnet according to the present embodiment may include an R-OCN phase at the grain boundary, namely a portion other than the R₂T₁₄B main phase crystal grains. The R-OCN phase is a phase including larger contents of R, O, C, and N compared to the content of each element in the R₂T₁₄B main phase crystal grains. In the R-T-B based permanent magnet according to the present embodiment, the volume proportion of the R-OCN phase with respect to the grain boundary may be 34.0% or less, may be 31.5% or less, or may be 29.9% or less. While the R-T-B based permanent magnet does not necessarily include the R-OCN phase, the volume proportion of the R-OCN phase may be 18.4% or more.

The R-OCN phase has a high melting point and is less likely to melt even during sintering. Consequently, particularly when the area proportion of the R₂T₁₄B main phase crystal grains is large, presence of the R-OCN phase prevents grain growth of the R₂T₁₄B main phase crystal grains during sintering and distorts shapes of the R₂T₁₄B main phase crystal grains. The two-grain boundary thus tends to easily have an unsmooth shape. Reducing the volume proportion of the R-OCN phase, however, makes it difficult to prevent grain growth of the R₂T₁₄B main phase crystal grains during sintering and makes it easier for the two-grain boundary to have a smooth shape. Consequently, formation of a reverse magnetic domain can be prevented, and the temperature properties tend to be easily maintained suitably even when the area proportion of the R₂T₁₄B main phase crystal grains is large.

The R-T-B based permanent magnet according to the present embodiment may include an R₂O₃ phase at the grain boundary, namely the portion other than the R₂T₁₄B main phase crystal grains. As the content of O in the R-T-B based permanent magnet increases, R other than R included in the R₂T₁₄B main phase crystal grains easily bonds to O. This makes it easier for the R₂O₃ phase to be included and makes it more difficult for the R-OCN phase to be included. Reduction of the R-OCN phase makes it easier for the two-grain boundary to have a smooth shape and makes it more difficult for a reverse magnetic domain to be formed. However, when the R-OCN phase is reduced and the R₂O₃ phase is increased, C in excess due to the reduction of the R-OCN phase partly substitutes for B in the R₂T₁₄B main phase crystal grains. Consequently, the temperature properties are easily degraded. Also, increase of the R₂O₃ phase makes it easier to reduce R forming the R₂T₁₄B main phase crystal grains and to decrease Br. Further, the R₂O₃ phase does not contribute to improvement of Hcj at all. Thus, as the content of O increases, Hcj easily decreases.

The R-T-B based permanent magnet according to the present embodiment may include an R-rich phase in addition to the R-OCN phase and the R₂O₃ phase mentioned above at the grain boundary, namely the portion other than the R₂T₁₄B main phase crystal grains. The R-rich phase of the present embodiment is a phase including a larger content of R compared to the content of R in the R₂T₁₄B main phase crystal grains and a smaller content of O compared to the content of O in the R₂T₁₄B main phase crystal grains.

Hereinafter, a method of calculating the area proportion of the R₂T₁₄B main phase crystal grains and a method of calculating the volume proportion of the R-OCN phase are described.

The area proportion is calculated with a backscattered electron image obtained using, for example, a field emission scanning electron microscopy (FE-SEM). When the FE-SEM is used, a sample for the FE-SEM is prepared first. Specifically, the R-T-B based permanent magnet is embedded into epoxy-based resin and is polished so that a cross section parallel to the orientation direction of the R-T-B based permanent magnet can be observed. Regarding polishing, specifically, rough polishing using a normal method is performed, and then final polishing is performed. The final polishing is performed so that the cross section has luster. A method of the final polishing is not particularly limited to a specific one. It is preferred that the final polishing is dry polishing, in which a polishing solution (e.g., water) is not used. When the polishing solution (e.g., water) is used, it might not be possible to perform appropriate analysis due to corrosion of a grain boundary phase. Next, ion milling is performed on the polished cross section of the R-T-B based permanent magnet to remove an oxide film, a nitride film, or the like on the polished surface.

Next, the cross section of the R-T-B based permanent magnet is then observed using the FE-SEM. A backscattered electron image having a size of 50 m squared or more and 100 μm squared or less is obtained at a magnification of 1000 or more and 3000 or less. From a contrast of the backscattered electron image and EDS point analysis results, it can be confirmed that the R-T-B based permanent magnet includes the main phase crystal grains (main phases) and other portions (grain boundary phases). The area proportion of each phase can thereby be calculated. More specifically, by comparing the results of the point analysis using an energy-dispersive X-ray spectroscopy (EDS) attached to the FE-SEM and the contrast of the backscattered electron image, the phases can be classified into the R₂T₁₄B main phase crystal grains (main phases) and other phases (grain boundary phases) such as the R-rich phase, the R-OCN phase, the R₂O₃ phase, and an R₆T₁₃M phase. Note that, M is at least one element selected from the group consisting of Ga, Sn, Si, Cu, etc. The R₂T₁₄B main phase crystal grains and the other phases can be distinguished based on the EDS measurement results, and the area proportion of each phase can be calculated based on differences in the contrast of the phases.

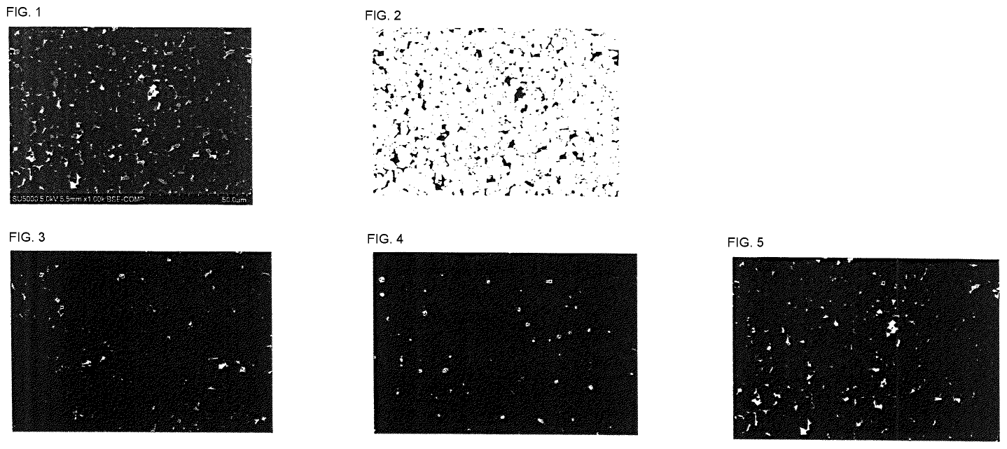

To calculate the area proportion of the R₂T₁₄B main phase crystal grains, the backscattered electron image is first binarized. For example, binarizing the backscattered electron image of the R-T-B based permanent magnet illustrated as FIG. 1 so that the R₂T₁₄B main phase crystal grains are shown in white provides an image illustrated as FIG. 2. The grain boundary generally includes a larger content of the rare-earth element R compared to the R₂T₁₄B main phase crystal grains. Here, the rare-earth element R is the element having an especially large atomic number among elements normally included in the R-T-B based permanent magnet. Usually, the larger the content of the element having the large atomic number, the stronger the signal strength of the backscattered electron image, and the brighter the image. By comparing the EDS point analysis results and the contrast of the backscattered electron image and extracting a region having a signal strength stronger than a predetermined level, the R₂T₁₄B main phase crystal grains and the grain boundary can be distinguished, thereby enabling binarization. Note that, because the two-grain boundary formed in between two R₂T₁₄B main phase crystal grains is thin, the two-grain boundary is scarcely observed in FIG. 2. However, an area occupied by the two-grain boundary is small enough to be within a margin of error, seen from a view of the entire area of the grain boundary. Consequently, in calculating the area proportion of the R₂T₁₄B main phase crystal grains, the two-grain boundary being unobserved in FIG. 2 is not a problem.

To calculate the volume proportion of the R-OCN phase in the grain boundary, the area proportion of the grain boundary phases is first calculated using FIG. 2, which is an FE-SEM image obtained through binarization of the backscattered electron image of the R-T-B based permanent magnet illustrated as FIG. 1. Next, the EDS point analysis results and the contrast of the backscattered electron image are compared to identify each grain boundary phase. FIGS. 3 to 5 are binarized FE-SEM images illustrating the R₆T₁₃M phase, the R-OCN phase, and the R-rich phase in white respectively. Here, the area proportion of the R-OCN phase in the grain boundary can be calculated by dividing the area of the R-OCN phase by the area of the grain boundary phases. In the present embodiment, the area proportion of the R-OCN phase in the grain boundary is deemed to be equivalent to the volume proportion of the R-OCN phase in the grain boundary. The volume proportion of the R-OCN phase in the grain boundary is calculated in such a manner.

Hereinafter, a method of calculating the coverage ratio of the R₂T₁₄B main phase crystal grains is described.

The above area proportion is calculated with a backscattered electron image obtained using a field emission scanning electron microscopy (FE-SEM). A sample for the FE-SEM is thus prepared first. A method of preparing the sample is the same as the method of preparing a sample in the above-mentioned calculation method of the area proportion of the R₂T₁₄B main phase crystal grains.

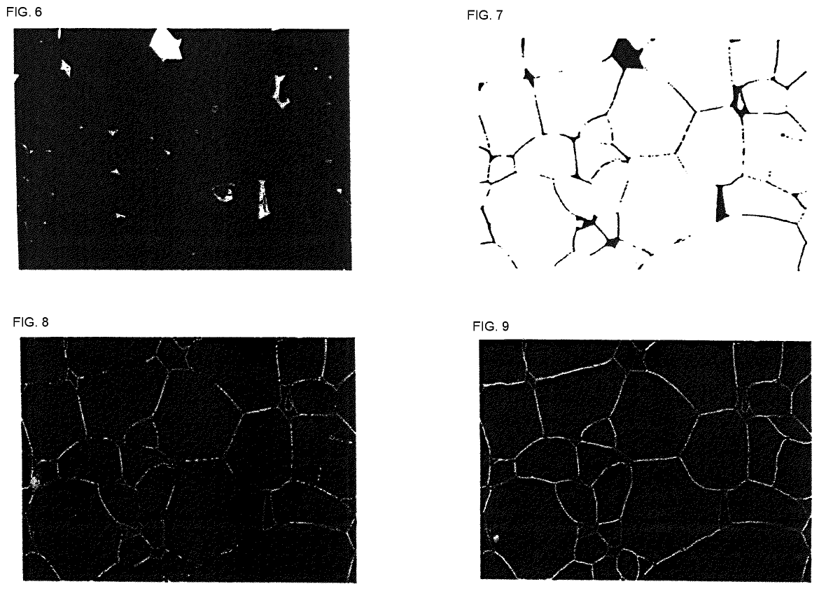

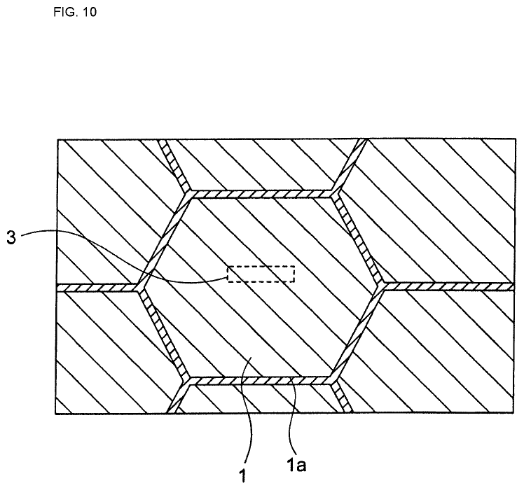

An obtained cross section of the R-T-B based permanent magnet is then observed using the FE-SEM. A backscattered electron image having a size of 10 m squared or more and 20 m squared or less and a resolution of 1280×960 pixels is obtained at a magnification of 5000 or more and 10000 or less. Next, the backscattered electron image is binarized so that the R₂T₁₄B main phase crystal grains are shown in white. For example, binarizing the backscattered electron image illustrated as FIG. 6 so that the R₂T₁₄B main phase crystal grains are shown in white provides an image illustrated as FIG. 7. Then, contours of the R₂T₁₄B main phase crystal grains are extracted from FIG. 7. Specifically, white portions (the R₂T₁₄B main phase crystal grains) in FIG. 7 that are in contact with black portions (secondary phases) in FIG. 7 are extracted. FIG. 8 shows the extracted result. A total length of the white portions (the contours of the R₂T₁₄B main phase crystal grains in contact with the secondary phases) in FIG. 8 is defined as “Aₜₒₜₐₗ”.

Next, a grain border where the R₂T₁₄B main phase crystal grains are in contact with each other is added to FIG. 8 manually. FIG. 9 shows the result after the addition. A length of the added grain border is defined as “Bₜₒₜₐₗ”. The coverage ratio is calculated using Aₜₒₜₐₗ/(Aₜₒₜₐₗi+Bₜₒₜₐₗ). The R₂T₁₄B main phase crystal grains that are partially out of the backscattered electron image are removed from the calculation of the coverage ratio.

A length at which an exchange interaction between the R₂T₁₄B main phase crystal grains is cut is typically about 3 nm. On the other hand, in the backscattered electron image obtained with the FE-SEM, a region having a width of roughly 20 nm or more can be recognized as a region having a contrast different from that of the R₂T₁₄B main phase crystal grains. The extracted contours shown in FIG. 8 are the contours of the R₂T₁₄B main phase crystal grains in contact with a grain boundary having a width of roughly 20 nm or more.

Hereinafter, a method of calculating the average thickness of the two-grain boundaries is described.

To calculate the average thickness of the two-grain boundaries, a high-resolution transmission electron microscopy (HR-TEM) is used, unlike when the area proportion of the R₂T₁₄B main phase crystal grains and the coverage ratio of the R₂T₁₄B main phase crystal grains are calculated as described above. A magnification of an HR-TEM image is not particularly limited and may be determined appropriately based on the thicknesses of the two-grain boundaries. For example, the magnification may be 500,000 or more and 2,000,000 or less. Next, at least twenty two-grain boundaries are selected to measure their thicknesses using the HR-TEM image. Then, a border between each of the selected two-grain boundaries and the triple junction connected with the two-grain boundary is determined.

The border is not necessarily determined with accuracy and may be determined by visual observation of the HR-TEM image. This is because potential differences between an accurate border location and a visually determined border location have little influence on a finally calculated average thickness of the two-grain boundaries and are within a margin of measurement error. Note that, the reason why the above mentioned potential differences have little influence on the finally calculated average thickness of the two-grain boundaries is because the vicinity of the triple junction where each selected two-grain boundary becomes thick is not subject to measurement of the thickness of the two-grain boundary regardless of whether the determined border locations include measurement error or not.

Next, three quadrisectors are drawn to quadrisect the two-grain boundary between adjacent borders. Locations of the three quadrisectors are where the thickness of the two-grain boundary is measured. That is, the thickness is measured at three locations for each selected two-grain boundary. By carrying out this measurement for at least twenty two-grain boundaries and working out their average, the average thickness of the two-grain boundaries can be calculated. This average thickness is deemed to be the average thickness of the two-grain boundaries in the entire R-T-B based permanent magnet.

Hereinafter, a magnet composition of the R-T-B based permanent magnet is described. A content of R is not particularly limited. The content of R may be 25.0 mass % or more and 35.0 mass % or less, may be 27.5 mass % or more and 32.0 mass % or less, may be 27.5 mass % or more and 31.5 mass % or less, or may be 28.0 mass % or more and 31.5 mass % or less. When the content of R is larger than a predetermined content, the R₂T₁₄B main phase crystal grains included in the R-T-B based permanent magnet are sufficiently and easily generated. This prevents deposition such as α-Fe having soft magnetism and makes it easier to prevent degradation of magnetic properties. When the content of R is smaller than a predetermined content, the area proportion of the R₂T₁₄B main phase crystal grains and the volume proportion of the R-OCN phase in the grain boundary are easily controlled within the predetermined ranges, and Br of the R-T-B based permanent magnet tends to increase.

R is not particularly limited to a specific element, but preferably includes at least RL. RL is not particularly limited to a specific element. RL may include at least Nd or Pr. RL may include Nd. When RH is included, RH is not particularly limited to a specific element. RH may include at least Dy or Tb. RH may include Tb. When RH is included, Hcj is easily improved, but Br and the temperature properties (ΔHcj/ΔT) are easily degraded.

A content of B in the R-T-B based permanent magnet according to the present embodiment is not particularly limited. The content of B may be 0.50 mass % or more and 1.50 mass % or less, may be 0.90 mass % or more and 1.05 mass % or less, or may be 0.92 mass % or more and 0.98 mass % or less. The content of B within a predetermined range makes it easier to increase the area proportion of the R₂T₁₄B main phase crystal grains and tends to improve Hcj and Br.

T may be Fe alone or may be Fe partly substituted by Co. A content of Fe in the R-T-B based permanent magnet according to the present embodiment is not particularly limited. The content of Fe may be the substantial remainder of the R-T-B based permanent magnet with inevitable impurities described below removed. A content of Co is preferably 0 mass % or more and 4.00 mass % or less and is more preferably 0.50 mass % or more and 3.00 mass % or less.

A content of N in the R-T-B based permanent magnet according to the present embodiment is not particularly limited. A small content of N, specifically 300 ppm or less, makes it easier to control the area proportion and the coverage ratio of the R₂T₁₄B main phase crystal grains within the predetermined ranges even if the content of C is large.

A content of H in the R-T-B based permanent magnet according to the present embodiment is not particularly limited. The content of H may be 100 ppm or less, or may be 50 ppm or less. Note that, a large content of H easily results in cracks in the R-T-B based permanent magnet.

When the R-T-B based permanent magnet according to the present embodiment is an R-T-B based sintered magnet, 50 ppm or less of H makes it easier to carry out sufficient sintering and to increase Br. An attempt to manufacture an R-T-B based sintered magnet with a content of H exceeding 100 ppm increases costs, makes it more difficult to sufficiently densify the R-T-B based sintered magnet, and makes it easier to reduce the residual magnetic flux density.

When the R-T-B based permanent magnet includes H, H may be included in between crystal lattices. The larger the content of H included in between the crystal lattices, the larger the crystal lattice strain. The crystal lattice strain makes it easier for the R-T-B based permanent magnet to have a large absolute value of the temperature coefficient R of coercivity and to have degraded temperature properties. Controlling the content of H within 50 ppm or less makes it easier to prevent the crystal lattice strain and to improve the temperature properties. Note that there is no particular lower limit to the content of H included in the R-T-B based permanent magnet according to the present embodiment. The content of H may be equivalent to or smaller than the detection limit, which is roughly 5 ppm.

The R-T-B based permanent magnet according to the present embodiment may include Ga, Cu, Al, and/or Zr as a metal element other than R, T, and B. A content of each element is not particularly limited.

The content of Ga may be 0 mass % or more and 1.00 mass % or less, or may be 0 mass % or more and 0.20 mass % or less. The content of Cu may be 0.01 mass % or more and 1.00 mass % or less, or may be 0.10 mass % or more and 0.20 mass % or less. The content of Al may be 0.03 mass % or more and 0.60 mass % or less. The content of Zr may be 0.05 mass % or more and 0.60 mass % or less. Particularly, the content of Ga not exceeding a predetermined content makes it easier to control the area proportion of the R₂T₁₄B main phase crystal grains and the volume proportion of the R-OCN phase in the grain boundary within the predetermined ranges and tends to increase Br of the R-T-B based permanent magnet.

Also, in addition to the above-mentioned elements, the R-T-B based permanent magnet may include inevitable impurities such as Mn, Ca, Cl, S, F, and the like provided that their content is 0.001 mass % or more and 1.0 mass % or less in total.

A grain size of the R₂T₁₄B main phase crystal grains is not particularly limited. The grain size is normally 10 m or less. The smaller the grain size of the R₂T₁₄B main phase crystal grains is, the easier it is for Hcj of the R-T-B based permanent magnet to increase. However, the smaller the grain size of the R₂T₁₄B main phase crystal grains is, the easier it is for the R₂T₁₄B main phase crystal grains to bond to oxygen in an atmosphere, and the easier it is for the content of O in the R-T-B based permanent magnet to increase.

The content of C included in the R₂T₁₄B main phase crystal grains in the R-T-B based permanent magnet according to the present embodiment may be 300 ppm or less.

The R-T-B based permanent magnet includes at least a very small content of C. A part of C included in the R-T-B based permanent magnet partly substitutes for B in the R₂T₁₄B main phase crystal grains. That is, C partly substitutes for B in the R₂T₁₄B main phase crystal grains included in the R-T-B based permanent magnet.

The present inventors have found that partial substitution of C for B in the R₂T₁₄B main phase crystal grains reduces the Curie temperature of the R-T-B based permanent magnet. The present inventors have also found that reducing the content of the partial substitution of C for B in the R₂T₁₄B main phase crystal grains makes it easier to increase the Curie temperature of the R-T-B based permanent magnet. Specifically, the present inventors have found that reducing the content of C in the R₂T₁₄B main phase crystal grains to 300 ppm or less makes it easier to increase the Curie temperature of the R-T-B based permanent magnet. Note that there is no particular lower limit to the content of C included in the R₂T₁₄B main phase crystal grains. For example, the content of C may be 10 ppm or more, or may be 20 ppm or more.

The present inventors have found that increasing the Curie temperature of the R-T-B based permanent magnet makes it easier to reduce the absolute value of the temperature coefficient (β) of Hcj of the R-T-B based permanent magnet, i.e., to improve the temperature properties of the R-T-B based permanent magnet, and further makes it easier to increase Hcj of the R-T-B based permanent magnet.

Also, the R-T-B based permanent magnet according to the present embodiment may have a degree of orientation (Br/Js) of 94% or more. The degree of orientation is defined by dividing the residual magnetic flux density (Br) by a saturation magnetic flux density (Js) in the orientation direction. A high degree of orientation makes it easier to improve the temperature properties and to further achieve a sufficient residual magnetic flux density.

Also, a degree of crystal orientation measured with a Lotgering method may be 66% or more.

Hereinafter, a method of measuring the degree of crystal orientation with the Lotgering method in the present embodiment is described.

To measure the degree of crystal orientation of the R-T-B based permanent magnet, first, a magnetic pole face of the R-T-B based permanent magnet is mirror polished. Then, X-ray diffraction measurement is carried out on the mirror polished surface. Based on a diffraction peak obtained in the X-ray diffraction measurement, the degree of crystal orientation is calculated. In the Lotgering method, the expression shown below can be used to calculate the degree of crystal orientation fc based on an X-ray diffraction intensity I (001) of a (001) reflection component and an X-ray diffraction intensity I (hkl) of an (hkl) reflection component.

Note that, when the degree of crystal orientation is calculated with the Lotgering method, only the reflection component in the orientation direction, i.e., the (001) reflection component, among diffraction peaks is accumulated on the numerator of the expression shown below. All diffraction peaks are integrated on the denominator of the expression shown below. Consequently, the calculated degree of crystal orientation is a value rather smaller than the actual degree of crystal orientation. To calculate the actual degree of crystal orientation, it is preferred to perform vector correction on the diffraction peak. However, vector correction is not performed in the present embodiment.

$$fc = \frac{\sum I ( 00 l )}{\sum I ( hkl )} \times 100 \qquad Math . 1$$

<Method of Manufacturing the R-T-B Based Permanent Magnet>

Next, a method of manufacturing the R-T-B based permanent magnet according to the present embodiment is described. Hereinafter, a method of manufacturing the R-T-B based permanent magnet with powder metallurgy is described below as an example.

The method of manufacturing the R-T-B based permanent magnet according to the present embodiment includes a pressing step of obtaining a green compact by pressing a raw material powder, a hydrogen decarbonization step of reducing the volume proportion of the grain boundary by reducing the content of C included in the green compact, a sintering step of obtaining a sintered body by sintering the green compact after the decarbonization, and an aging treatment step of holding the sintered body at a temperature lower than a sintering temperature for a certain length of time.

Hereinafter, the method of manufacturing the R-T-B based permanent magnet is described in detail. A known method may be used as for matters not specifically described.

### [Raw Material Powder Preparation Step]

A raw material powder can be prepared using a known method. Although the R-T-B based permanent magnet of the present embodiment is manufactured with a one-alloy method using a single raw material alloy mainly including the R₂T₁₄B phases, a two-alloy method using two raw material alloys may be used to manufacture the R-T-B based permanent magnet.

First, raw material metals corresponding to the composition of the raw material alloy according to the present embodiment are prepared, and the raw material alloy corresponding to the present embodiment is manufactured from the raw material metals. A method of manufacturing the raw material alloy is not particularly limited. For example, a strip casting method may be used to manufacture the raw material alloy.

After the raw material alloy is manufactured, the raw material alloy is pulverized (pulverization step). The pulverization step may be carried out in two stages or in one stage. A pulverization method is not particularly limited. For example, various pulverizers may be used in the pulverization. For example, the pulverization step can be carried out in two stages, which are coarse pulverization and fine pulverization and a hydrogen pulverization treatment can be carried out in the coarse pulverization. Specifically, after hydrogen is stored in the raw material alloy at room temperature, dehydrogenation can be carried out in an Ar gas atmosphere at 400° C. or more and 650° C. or less for 0.5 hours or more and 2 hours or less. Additionally, in the fine pulverization, a lubricant (e.g., isobutyramide and methyl carbamate) can be added as a pulverization aid to the coarsely pulverized powder, and then the coarsely pulverized powder can be finely pulverized using, for example, a jet mill or a wet attritor. A particle size of the finely pulverized powder (raw material powder) is not particularly limited. For example, the fine pulverization can be carried out so that the finely pulverized powder (raw material powder) has a particle size (D50) of 1 m or more and m or less. Note that, steps from hydrogen storage pulverization to sintering are always carried out in a low-oxygen atmosphere with an oxygen concentration of less than 230 ppm.

Note that, the content of carbon included in the raw material alloy and the content of the lubricant used as the pulverization aid may be reduced to reduce a proportion of carbon in the raw material powder. However, it is preferred that the lubricant is added to some extent without reducing the proportion of carbon in the raw material powder. This is because addition of the lubricant to some extent makes it easier to increase Br/Js and the degree of crystal orientation in the pressing step described later and to improve the temperature properties. This is also because addition of the lubricant to some extent makes it easier to reduce the content of O included in the R-T-B based permanent magnet obtained in the end. Specifically, it is preferred that the content of the lubricant added is 0.05 mass % or more and 0.20 mass % or less.

### [Pressing Step]

In the pressing step, the finely pulverized powder (raw material powder) obtained through the pulverization step is pressed into a predetermined shape. A pressing method is not particularly limited. In the present embodiment, the finely pulverized powder (raw material powder) is filled in a mold, and a pressure is applied in a magnetic field. With application of pressure in the magnetic field, the R₂T₁₄B main phase crystal grains are oriented to the magnetic field direction.

The pressure applied during pressing is preferably 30 MPa or more and 300 MPa or less. The magnetic field applied is preferably 950 kA/m or more and 1600 kA/m or less. The magnetic field is not limited to a static magnetic field and may be a pulsed magnetic field. The static magnetic field and the pulsed magnetic field may be used concurrently. A shape of the green compact obtained by pressing the finely pulverized powder (raw material powder) is not particularly limited. The green compact may have any shape in accordance with a desired shape of the R-T-B based permanent magnet, such as a rectangular parallelepiped, a tabular shape, or a columnar shape.

### [Hydrogen Decarbonization Step]

In the present embodiment, a hydrogen decarbonization treatment, in which the volume proportion of the grain boundary is reduced by reducing the content of C in the obtained green compact, may be carried out after the above-mentioned pressing step. Note that C included in the green compact at the time after the pressing step is mainly attributable to the lubricant. Carrying out the hydrogen decarbonization treatment enables the lubricant to be decomposed with hydrogen, thus removing the lubricant from the green compact. Consequently, C can be removed even if the lubricant has been added to some extent. Further, hydrogen penetrates into a material efficiently. Consequently, the content of carbon particularly included in the R₂T₁₄B main phase crystal grains is reduced. This makes it easier to reduce the volume proportion of the grain boundary in the R-T-B based permanent magnet obtained in the end and to control the area proportion of the R₂T₁₄B main phase crystal grains to 92.0% or more.

The hydrogen decarbonization treatment is carried out by heating the green compact in a hydrogen atmosphere or a hydrogen and inert gas (e.g., Ar gas) atmosphere. A proportion of the hydrogen gas in the atmosphere may be 5% or more and 100% or less in terms of molecular number ratio. The ambient pressure may be atmospheric pressure (101 kPa) or lower. Specifically, the ambient pressure may be 5 kPa or more and 101 kPa or less. The length of heating time is not particularly limited and may be 1 hour or more and 30 hours or less. A heating temperature is not particularly limited and may be 150° C. or more and 600° C. or less.

When the hydrogen decarbonization treatment is carried out, it is important that the hydrogen decarbonization treatment is carried out after the pressing step and before the sintering step described later. If the hydrogen decarbonization treatment is carried out before the pressing step, Br/Js and the degree of crystal orientation are reduced, and the residual magnetic flux density is reduced. If the hydrogen decarbonization treatment is carried out after the sintering step, the sintered body may expand due to hydrogen storage until it cracks. Besides, carbon included in the green compact further enters into the R₂T₁₄B main phase crystal grains and the grain boundary through sintering. Carbon that has entered into the R₂T₁₄B main phase crystal grains and the grain boundary through sintering cannot be sufficiently removed even if the hydrogen decarbonization treatment is carried out.

The hydrogen decarbonization treatment and sintering described later may be carried out continuously. Specifically, the green compact may be left in a furnace where the hydrogen decarbonization treatment has been carried out and may be sintered there in a changed atmosphere gas, at a changed temperature, and the like.

### [Sintering Step]

The sintering step is a step of sintering the green compact in a vacuum or an inert gas atmosphere to obtain the sintered body. A sintering temperature needs to be adjusted in accordance with conditions (e.g., composition, pulverization method, particle size, and particle size distribution). The green compact is sintered, for example, through a heating treatment in the vacuum or under the presence of the inert gas at a temperature of 1000° C. or more and 1200° C. or less for 1 hour or more and 10 hours or less. The sintered body (permanent magnet) having a high density is thereby obtained.

### [Aging Treatment Step]

The aging treatment step is carried out by heating the sintered body (permanent magnet) having gone through the sintering step, at a temperature lower than the sintering temperature in the vacuum or the inert gas atmosphere. Aging treatment temperature and time are not particularly limited. The aging treatment step may be carried out, for example, at a temperature of 450° C. or more and 900° C. or less for 0.2 hours or more and 3 hours or less. Note that, the aging treatment step may be skipped.

Also, the aging treatment step may be carried out in one stage or in two stages. When two stages are included, a first stage may be heating at a temperature of 700° C. or more and 900° C. or less for 0.2 hours or more and 3 hours or less, and a second stage may be heating at a temperature of 450° C. or more and 700° C. or less for 0.2 hours or more and 3 hours or less. Also, the first stage and the second stage may be carried out continuously. The sintered body may once be cooled to near room temperature after the first stage and may then be heated again in the second stage.

### [Diffusion Treatment Step]

A diffusion treatment, in which the heavy rare-earth element is diffused from an outer surface side of the permanent magnet to an inner side of the permanent magnet, may be performed for the obtained permanent magnet. A diffusion treatment method is not particularly limited. For example, an application diffusion method may be used, in which the permanent magnet is heated while having a powder, foil, or the like including the heavy rare-earth element adhered. For example, a gas phase diffusion method may be used, in which the permanent magnet is heated in an atmosphere where the heavy rare-earth element is vaporized.

Note that, the materials may avoid contact with nitrogen in all steps from the coarse pulverization to sintering. Using a highly pure Ar gas, an atmosphere used in all steps from the coarse pulverization to sintering may have a nitrogen concentration of 200 ppm or less. In this case, the content of nitrogen in the R-T-B based permanent magnet obtained in the end can be reduced. Consequently, the area proportion of the R₂T₁₄B main phase crystal grains and the volume proportion of the R-OCN phase can be controlled within the predetermined ranges without carrying out the above-mentioned hydrogen decarbonization treatment.

Hereinabove, the preferable embodiment of the R-T-B based permanent magnet of the present invention is described. However, the above-mentioned embodiment should not be construed to limit the R-T-B based permanent magnet of the present invention. The R-T-B based permanent magnet of the present invention can be variously modified and various combinations are possible, within the scope of the invention.

Further, the R-T-B based permanent magnet according to the present embodiment may be cut and divided into two or more R-T-B based permanent magnets.

Use of the R-T-B based permanent magnet according to the present embodiment is not particularly limited. Specifically, the R-T-B based permanent magnet according to the present embodiment is suitably used for a motor, a compressor, a magnetometer, a speaker, or the like.

The two or more R-T-B based permanent magnets may be bonded together as necessary. A bonding method is not particularly limited. For example, the R-T-B based permanent magnets may be bonded mechanically or may be bonded by resin molding.

Bonding the two or more R-T-B based permanent magnets enables easy manufacture of a large R-T-B based permanent magnet. A magnet including the two or more R-T-B based permanent magnets bonded together is preferably used for purposes requiring a particularly large R-T-B based permanent magnet, such as an IPM motor, a wind power generator, a large motor, or the like.

### EXAMPLES

Next, the present invention is described in further detail based on specific examples. However, the present invention is not limited to the following examples.

### Experimental Example 1

Nd, Pr, electrolytic iron, and a low-carbon ferro-boron alloy were prepared as raw material metals. Further, Ga, Al, Cu, Co, and Zr were prepared in a form of a pure metal or an alloy with Fe.

With a strip casting method, raw material alloys were prepared using the raw material metals. Specifically, alloys A to H each having a composition shown in Table 1 were prepared as the raw material alloys. Each raw material alloy had a thickness of 0.2 to 0.6 mm.

TABLE 1

| | Mass % | | | | | | | | |
|---|---|---|---|---|---|---|---|---|---|
| Alloy | Nd | Pr | Al | Cu | Zr | Ga | Co | B | Fe |
| A | 22.6 | 7.5 | 0.20 | 0.10 | 0.20 | 0.00 | 1.00 | 0.95 | bal. |
| B | 23.2 | 7.7 | 0.20 | 0.10 | 0.20 | 0.00 | 1.00 | 0.93 | bal. |
| C | 24.0 | 8.0 | 0.20 | 0.10 | 0.20 | 0.00 | 1.00 | 0.92 | bal. |
| D | 22.5 | 7.5 | 0.20 | 0.20 | 0.20 | 0.20 | 1.00 | 0.92 | bal. |
| E | 24.0 | 8.0 | 0.20 | 0.20 | 0.10 | 0.50 | 0.90 | 0.85 | bal. |
| F | 23.8 | 7.6 | 0.20 | 0.10 | 0.20 | 0.00 | 1.00 | 0.93 | bal. |
| G | 27.5 | 0.0 | 0.20 | 0.10 | 0.20 | 0.00 | 0.50 | 0.97 | bal. |
| H | 26.5 | 0.0 | 0.20 | 0.10 | 0.20 | 0.00 | 0.50 | 0.97 | bal. |

Next, hydrogen was stored in the raw material alloy by letting a hydrogen gas flow at room temperature for 1 hour. Then, an atmosphere was changed to an Ar gas, and the raw material alloy was hydrogen crushed through a dehydrogenation treatment at 450° C. for 1 hour. Further, using a sieve after cooling, the raw material alloy was made into a powder having a particle size of 400 m or less.

Next, a lubricant as a pulverization aid was added to the powder of the raw material alloy after being hydrogen crushed, and was mixed with the powder. The content of the added lubricant was as shown in Table 2 in mass percent. Isobutyramide was used as the lubricant. Note that, the content of C and the content of O in the magnet composition were controlled by controlling the addition amount of the lubricant.

Next, each raw material alloy powder was finely pulverized under a nitrogen stream using an impact plate type jet mill apparatus to obtain a fine powder (raw material powder) having an average particle size of about 4 m. The average particle size was D50 measured with a laser diffraction particle size analyzer.

Note that, the content of O in the magnet composition was controlled by changing the content of oxygen in the atmosphere used in the pulverization. The content of oxygen in the atmosphere used in the pulverization in Example 4, which had the largest content of O in all Examples, was 200 ppm. Also, the content of oxygen in the atmosphere used in the pulverization in Comparative Example 3, which had the largest content of O in all Comparative Examples, was 900 ppm.

Note that, Si, Ca, La, Ce, Cr, etc. may be detected as inevitable impurities or the like. Si may be mainly attributable to the ferro-boron alloy prepared as a raw material metal, and to a crucible used at the time of melting raw material metals. Ca, La, and Ce may be attributable to a rare-earth element material. Cr may be attributable to electrolytic iron.

The obtained fine powder was pressed in a magnetic field to manufacture a green compact. At this time, the applied magnetic field was a static magnetic field of 1200 kA/m. The pressure applied during pressing was 120 MPa. Note that, a direction of magnetic field application and a direction of pressure application were orthogonal to each other. In measurement of a green compact density at this time, all green compacts had a density within a range of 4.10 Mg/m³ or more and 4.25 Mg/m³ or less.

Next, in Examples and Comparative Examples other than Comparative Examples 2 and 5 to 7, a hydrogen decarbonization treatment was carried out for the green compact. Except for Example 6, an atmosphere of the hydrogen decarbonization treatment was a hydrogen atmosphere (under atmospheric pressure, with a hydrogen partial pressure of 101 kPa). In Example 6, an atmosphere of the hydrogen decarbonization treatment was a hydrogen-Ar mixed atmosphere (under atmospheric pressure, with a hydrogen partial pressure of 50 kPa and an Ar partial pressure of 51 kPa). A heating temperature (hydrogen treatment temperature) is shown in Table 2. A heating time was 1 to 48 hours. Note that, the content of C and the content of H in the magnet composition were controlled by controlling conditions of the hydrogen decarbonization treatment.

Then, the green compact was sintered to obtain a permanent magnet. Sintering conditions were as follows. The sintering temperature was 1060° C. and the holding time was 4 hours. The sintering atmosphere was a vacuum. At this time, the sintering density was within a range of 7.50 Mg/m³ or more and 7.55 Mg/m³ or less. After that, in an Ar atmosphere under atmospheric pressure, a first aging treatment was carried out for 1 hour at a first aging temperature T1 of 900° C., and a second aging treatment was further carried out for 1 hour at a second aging temperature T2 of 500° C.

The composition (the content of Nd, Pr, Al, Cu, Zr, Ga, Co, and Fe) of the R-T-B based permanent magnet obtained through the above steps in each Example and each Comparative Example was measured in fluorescent X-ray analysis. The content of B was measured using a high frequency inductively coupled plasma (ICP) emission spectroscopic analysis method. From the measurement results, it was confirmed that the composition (e.g., the content of R) of the R-T-B based permanent magnet was substantially the same as the composition of the raw material alloy and was as shown in Table 1.

The content of C, O, and H in the R-T-B based permanent magnet of each Example and each Comparative Example was measured. First, a surface portion of the R-T-B based permanent magnet was shaved off with a grinder. The R-T-B based permanent magnet was then pulverized into a size of about 1 mm with a stamp mill. From the pulverized R-T-B based permanent magnet, a measurement sample was randomly collected. The content of O and H was measured with an inert gas fusion —non-dispersive infrared absorption method. The content of C was measured with a combustion in oxygen stream-infrared absorption method. The above measurement was carried out for five times, and their averages were used as the content of C, O, and H in the R-T-B based permanent magnet. Tables 2 and 3 show results. Note that, a sample marked with “N.D.” for the content of H is a sample whose content of H was equivalent to or below a measurement limit and was roughly 5 ppm or less.

The content of C in R₂T₁₄B main phase crystal grains in the R-T-B based permanent magnet of each Example and each Comparative Example was measured with a three-dimensional atom probe (3DAP).

First, an electron microscope image of a polished cross section of each sample was obtained. Note that, the polished cross section was a cross section parallel to an orientation direction of the R-T-B based permanent magnet. Then, in the obtained electron microscope image, an R₂T₁₄B main phase crystal grain from which to extract a needle-shaped sample was selected. The selected R₂T₁₄B main phase crystal grain was an R₂T₁₄B main phase crystal grain with a grain size approximately equivalent to the average grain size.

Next, a sampling region from which to extract the needle-shaped sample was determined. A method of determining the sampling region is described below. FIG. 10 is a schematic diagram of an electron microscope image including a selected R₂T₁₄B main phase crystal grain 1. An example of the sampling region, or a sampling region 3, is indicated in FIG. 10. The sampling region 3 was determined so that it included a portion near a center of the selected R₂T₁₄B main phase crystal grain 1 and excluded an end portion 1a of the selected R₂T₁₄B main phase crystal grain 1. The portion near the center of the selected R₂T₁₄B main phase crystal grain 1 was, specifically, where a distance from the incenter of the selected R₂T₁₄B main phase crystal grain 1 was 100 nm or less. Also, the sampling region 3 was determined so that its length in a longitudinal direction was 500 nm or more. Note that, an angle formed by the longitudinal direction of the sampling region 3 and an orientation axis of the selected R₂T₁₄B main phase crystal grain 1 was not particularly limited. For example, the longitudinal direction of the sampling region 3 may be parallel to the orientation axis or may be orthogonal to the orientation axis.

Next, the needle-shaped sample was sampled from the sampling region 3. Specifically, the needle-shaped sample was extracted from the sampling region 3. The needle-shaped sample was extracted so that its length in the longitudinal direction was 500 nm or more. The above extraction of the needle-shaped sample was carried out for five different R₂T₁₄B main phase crystal grains 1. Then, the three-dimensional atom probe measurement was carried out for at least consecutive 500 nm in each of the five needle-shaped samples to measure the content of C in each needle-shaped sample. Their average value was used as the content of C in the R₂T₁₄B main phase crystal grains in the R-T-B based permanent magnet. The extraction of the needle-shaped samples was carried out so that a secondary phase in the R₂T₁₄B main phase crystal grains was not included. Tables 2 and 3 show results.

Magnetic properties and an degree of orientation (Br/Js), which was calculated by dividing a residual magnetic flux density by a saturation magnetic flux density in the orientation direction, of the R-T-B based permanent magnet of each Example and each Comparative Example were calculated. First, a surface of the R-T-B based permanent magnet was ground so that it had a cubic shape with a size of 10.0 mm×10.0 mm×10.0 mm. Then, coercivity Hcj, the residual magnetic flux density Br, and the saturation magnetic flux density Js of the ground R-T-B based permanent magnet were measured with a BH tracer at room temperature (23° C.), and Br/Js was calculated. Further, coercivity Hcj was measured with the BH tracer at 160° C., and a temperature coefficient β of coercivity was calculated. Tables 2 and 3 show results. Br/Js was deemed good when it was 94% or more. Hcj at room temperature was deemed good when it was 15.0 kOe or more. Br at room temperature was deemed good when it was 14.0 kG or more. Hcj at 160° C. was deemed good when it was 5.0 kOe or more. The temperature coefficient β of coercivity was deemed good when its absolute value was less than 0.50%/° C.

An area proportion of the R₂T₁₄B main phase crystal grains, a volume proportion of an R-OCN phase in a grain boundary, a coverage ratio, and an average thickness of two-grain boundaries of the R-T-B based permanent magnet of each Example and each Comparative Example were calculated. Tables 2 and 3 show results. FIGS. 1 to 9 show FE-SEM measurement results of Example 1.

A degree of crystal orientation of the R-T-B based permanent magnet of each Example and each Comparative Example was measured with the Lotgering method.

A magnetic pole face of the permanent magnet of each Example and each Comparative Example was mirror polished. Then, X-ray diffraction measurement of the mirror polished surface was carried out, and the degree of crystal orientation was calculated with the Lotgering method based on an obtained diffraction peak. Vector correction was not performed. Tables 2 and 3 show results.

TABLE 2

| | | | Hydrogen decarbonization | | | | | |
|---|---|---|---|---|---|---|---|---|
| | | | Hydrogen | Argon | Hydrogen | | | |
| | | Content of | partial | partial | treatment | | | |
| | Alloy | lubricant | pressure | pressure | temperature | Composition | | |
| | composition | (mass %) | (kPa) | (kPa) | (° C.) | C (ppm) | O (ppm) | H (ppm) |
| Example 1 | A | 0.12 | 101 | 0 | 500 | 80 | 620 | N.D. |
| Example 2 | A | 0.12 | 101 | 0 | 350 | 170 | 610 | N.D. |
| Example 3 | A | 0.12 | 101 | 0 | 200 | 540 | 630 | 50 |
| Example 4 | A | 0.12 | 101 | 0 | 215 | 480 | 890 | 20 |
| Example 5 | B | 0.12 | 101 | 0 | 210 | 490 | 620 | 10 |
| Example 6 | A | 0.12 | 50 | 51 | 350 | 290 | 600 | N.D. |
| Example 7 | D | 0.12 | 101 | 0 | 340 | 180 | 570 | N.D. |
| Example 8 | F | 0.12 | 101 | 0 | 215 | 480 | 620 | N.D. |
| Example 9 | G | 0.12 | 101 | 0 | 500 | 110 | 560 | N.D. |
| Comparative Example 1 | A | 0.12 | 101 | 0 | 160 | 650 | 600 | N.D. |
| Comparative Example 2 | A | 0.12 | None | | | 960 | 590 | N.D. |
| Comparative Example 3 | A | 0.12 | 101 | 0 | 230 | 470 | 2100 | N.D. |
| Comparative Example 4 | C | 0.12 | 101 | 0 | 215 | 490 | 620 | N.D. |
| Comparative Example 5 | E | 0.12 | None | | | 940 | 600 | N.D. |
| Comparative Example 6 | A | 0.03 | None | | | 320 | 1050 | N.D. |
| Comparative Example 7 | G | 0.12 | None | | | 940 | 590 | N.D. |
| Comparative Example 8 | H | 0.12 | 101 | 0 | 500 | 440 | 1950 | 20 |

| | Microstructure | | | | | | |
|---|---|---|---|---|---|---|---|
| | | | | | Content | | |
| | | | | | of C in | | |
| | | Main | R-OCN | Average | main | | Degree of |
| | | phase | phase | grain | phase | Degree of | crystal |
| | | area | volume | boundary | crystal | orientation | orientation |
| | Coverage | proportion | proportion | thickness | grams | (Br/Js) | (Lotgering |
| | ratio (%) | (%) | (%) | (nm) | (ppm) | (%) | method) |
| Example 1 | 69.4 | 93.5 | 18.4 | 21 | 20 | 94 | 67 |
| Example 2 | 64.4 | 94.4 | 22.3 | 17 | 50 | 94 | 67 |
| Example 3 | 59.0 | 94.0 | 29.9 | 6 | 290 | 95 | 67 |
| Example 4 | 53.4 | 93.5 | 29.0 | 7 | 220 | 94 | 67 |
| Example 5 | 56.2 | 92.0 | 27.9 | 10 | 250 | 94 | 67 |
| Example 6 | 61.0 | 94.6 | 25.8 | 13 | 180 | 94 | 67 |
| Example 7 | 68.5 | 94.4 | 22.8 | 16 | 80 | 94 | 67 |
| Example 8 | 66.1 | 92.0 | 27.1 | 8 | 240 | 94 | 67 |
| Example 9 | 51.7 | 94.8 | 18.0 | 6 | 30 | 94 | 67 |
| Comparative Example 1 | 42.8 | 93.7 | 31.5 | 4 | 240 | 94 | 67 |
| Comparative Example 2 | 27.7 | 94.7 | 34.4 | 2 | 450 | 93 | 67 |
| Comparative Example 3 | 36.7 | 93.7 | 30.5 | 3 | 320 | 92 | 66 |
| Comparative Example 4 | 68.4 | 87.7 | 27.8 | 10 | 250 | 92 | 67 |
| Comparative Example 5 | 63.1 | 87.3 | 36.1 | 11 | 480 | 92 | 65 |
| Comparative Example 6 | 47.8 | 94.0 | 25.3 | 6 | 185 | 88 | 58 |
| Comparative Example 7 | 21.2 | 94.3 | 28.8 | 2 | 400 | 92 | 66 |
| Comparative Example 8 | 30.1 | 89.9 | 30.1 | 2 | 310 | 92 | 66 |

TABLE 3

| | | | | Microstructure | | Curie |
|---|---|---|---|---|---|---|
| | Composition | | | Coverage | Main phase area | temperature |
| | C (ppm) | O (ppm) | H (ppm) | ratio (%) | proportion (%) | (° C.) |
| Example 1 | 80 | 620 | N.D. | 69.4 | 93.5 | 305 |
| Example 2 | 170 | 610 | N.D. | 64.4 | 94.4 | 304 |
| Example 3 | 540 | 630 | 50 | 59.0 | 94.0 | 301 |
| Example 4 | 480 | 890 | 20 | 53.4 | 93.5 | 302 |
| Example 5 | 490 | 620 | 10 | 56.2 | 92.0 | 301 |
| Example 6 | 290 | 600 | N.D. | 61.0 | 94.6 | 302 |
| Example 7 | 180 | 570 | N.D. | 68.5 | 94.4 | 304 |
| Example 8 | 480 | 620 | N.D. | 66.1 | 92.0 | 301 |
| Example 9 | 110 | 560 | N.D. | 51.7 | 94.8 | 304 |
| Comparative Example 1 | 650 | 600 | N.D. | 42.8 | 93.7 | 301 |
| Comparative Example 2 | 960 | 590 | N.D. | 27.7 | 94.7 | 297 |
| Comparative Example 3 | 470 | 2100 | N.D. | 36.7 | 93.7 | 300 |
| Comparative Example 4 | 490 | 620 | N.D. | 68.4 | 87.7 | 301 |
| Comparative Example 5 | 940 | 600 | N.D. | 63.1 | 87.3 | 297 |
| Comparative Example 6 | 320 | 1050 | N.D. | 37.8 | 94.0 | 302 |
| Comparative Example 7 | 940 | 590 | N.D. | 21.2 | 94.3 | 298 |
| Comparative Example 8 | 440 | 1950 | 20 | 30.1 | 89.9 | 299 |

Magnetic properties (160° C.)

| | Magnetic properties | | Temperature | | |
|---|---|---|---|---|---|
| | (room temperature) | | coefficient β of | | ΔHcj/ΔT |
| | Br (kG) | Hcj (kOe) | coercivity (%/° C.) | Hcj (kOe) | (kA/(m · ° C.)) |
| Example 1 | 14.5 | 17.5 | −0.45 | 6.7 | −6.3 |
| Example 2 | 14.6 | 16.9 | −0.47 | 6.0 | −6.3 |
| Example 3 | 14.6 | 16.5 | −0.49 | 5.4 | −6.4 |
| Example 4 | 14.5 | 15.6 | −0.49 | 5.1 | −6.1 |
| Example 5 | 14.2 | 16.3 | −0.48 | 5.6 | −6.2 |
| Example 6 | 14.5 | 16.6 | −0.48 | 5.7 | −6.3 |
| Example 7 | 14.4 | 17.1 | −0.45 | 6.5 | −6.1 |
| Example 8 | 14.2 | 17.1 | −0.45 | 6.5 | −6.2 |
| Example 9 | 14.9 | 15.2 | −0.49 | 4.9 | −5.9 |
| Comparative Example 1 | 14.4 | 15.6 | −0.52 | 4.5 | −6.5 |
| Comparative Example 2 | 14.4 | 14.3 | −0.57 | 3.1 | −6.5 |
| Comparative Example 3 | 14.3 | 13.7 | −0.54 | 3.6 | −5.9 |
| Comparative Example 4 | 13.7 | 17.4 | −0.45 | 6.7 | −6.2 |
| Comparative Example 5 | 13.6 | 15.4 | −0.48 | 5.3 | −5.9 |
| Comparative Example 6 | 13.6 | 16.1 | −0.50 | 5.1 | −6.4 |
| Comparative Example 7 | 14.4 | 12.2 | −0.55 | 2.1 | −5.9 |
| Comparative Example 8 | 13.1 | 8.9 | −0.60 | 1.6 | −4.2 |

In each of Examples 1 to 7, in which a lubricant of 0.12 mass % was added as a pulverization aid and the hydrogen decarbonization treatment was carried out, the area proportion of the main phase crystal grains was 92.0% or more, and the coverage ratio was 50.0% or more. Consequently, the magnetic properties at room temperature and the magnetic properties at 160° C. were both excellent, and temperature properties were good.

In Example 8, the content of R was 31.4 mass %, which was larger than the content of R in Examples 1 to 7. In Example 9, the content of R was 27.5 mass %, which was smaller than the content of R in Examples 1 to 7. In both Examples 8 and 9, however, the area proportion of the main phase crystal grains and the coverage ratio were within predetermined ranges, and good properties were obtained. It was confirmed that, even if the content of R was particularly small and sintering was difficult, provided that the area proportion of the main phase crystal grains and the coverage ratio were within the predetermined ranges, R was less likely to be present in the grain boundary such as a triple junction and the R-T-B based sintered magnet maintained a sufficiently high density.

On the other hand, the coverage ratio was too low in Comparative Example 1, in which most conditions were the same as those of each Example except that the heating temperature in the hydrogen decarbonization treatment was low, and in Comparative Example 2, in which most conditions were the same as those of each Example except that the hydrogen decarbonization treatment was not carried out. Consequently, the temperature properties were degraded. Further, coercivity decreased. In Comparative Example 5, in which the content of B was reduced and the content of Ga was increased from those of Comparative Example 2, the area proportion of the R₂T₁₄B main phase crystal grains was too small. Consequently, Br at room temperature decreased.

In Comparative Example 3, in which the content of O in the R-T-B based permanent magnet was large, the coverage ratio decreased, Hcj at room temperature decreased, and the temperature properties were degraded.

In Comparative Example 4, in which the alloy composition included a relatively large content of R, the area proportion of the R₂T₁₄B main phase crystal grains decreased, and Br at room temperature decreased.

In Comparative Example 6, in which the content of the lubricant was small and the hydrogen decarbonization treatment was not carried out, the coverage ratio decreased. Also, the degree of crystal orientation decreased, and Br at room temperature decreased. Further, the temperature properties were degraded.

In Comparative Example 7, in which the content of R in the R-T-B based permanent magnet was small and the hydrogen decarbonization treatment was not carried out, the coverage ratio decreased. Consequently, the sintered body had a low density, Br and Hcj particularly considerably decreased, and the temperature properties were particularly considerably degraded.

In Comparative Example 8, in which the content of O was large and the content of R was small in the R-T-B based permanent magnet, the coverage ratio decreased, and the area proportion of the R₂T₁₄B main phase crystal grains was too small. Consequently, the sintered body had a low density, Br and Hcj particularly considerably decreased, and the temperature properties were particularly considerably degraded.

### Experimental Example 2

In Experimental Example 2, materials avoided contact with nitrogen in all steps from coarse pulverization to sintering, unlike Experimental Example 1. Specifically, a nitrogen gas was not used in all the above steps, and a highly pure argon gas was used instead. Also, unlike Experimental Example 1, the hydrogen decarbonization treatment was not carried out in Experimental Example 2. Other than the conditions described above, conditions of Experimental Example 2 were the same as those of Example 1 in Experimental Example 1. Tables 4 and 5 show results. Note that the content of N was measured with an inert gas fusion—thermal conductivity method, unlike the content of O and H.

TABLE 4

| | | | Hydrogen decarbonization | | | | | | |
|---|---|---|---|---|---|---|---|---|---|
| | | | Hydrogen | Argon | Hydrogen | | | | |
| | | Content of | partial | partial | treatment | | | | |
| | Alloy | lubricant | pressure | pressure | temperature | Composition | | | |
| | composition | (mass %) | (kPa) | (kPa) | (° C.) | C (ppm) | O (ppm) | N (ppm) | H (ppm) |
| Example 1 | A | 0.12 | 101 | 0 | 500 | 80 | 620 | 630 | N.D. |
| Example 10 | A | 0.12 | None | | | 740 | 490 | 90 | N.D. |
| | | | Microstructure | | | | | | |
| | | | | Main | R-OCN | Average | Content of C | | Degree of |
| | | | | phase area | phase volume | grain boundary | in main phase | Degree of | crystal orientation |
| | | | Coverage | proportion | proportion | thickness | crystal grains | orientation | (Lotgering |
| | | | ratio (%) | (%) | (%) | (nm) | (ppm) | (Br/Js) (%) | method) |
| | | Example 1 | 69.4 | 93.5 | 18.4 | 21 | 20 | 94 | 67 |
| | | Example 10 | 50.4 | 94.3 | 30.8 | 9 | 410 | 94 | 67 |

| | | | | | Microstructure | | | | | Magnetic properties (160° C.) | | |
|---|---|---|---|---|---|---|---|---|---|---|---|---|
| | | | | | | Main | | | | Temperature | | |
| | Composition | | | | | phase area | Curie | Magnetic properties | | coefficient β | | |
| | C | O | N | H | Coverage | proportion | temperature | (room temperature) | | of coercivity | | ΔHcj/ΔT |
| | (ppm) | (ppm) | (ppm) | (ppm) | ratio (%) | (%) | (° C.) | Br (kG) | Hcj (kOe) | (%/° C.) | Hcj (kOe) | (kA/(m · ° C.)) |
| Example 1 | 80 | 620 | 630 | N.D. | 69.4 | 93.5 | 305 | 14.5 | 17.5 | −0.45 | 6.7 | −6.3 |
| Example 10 | 740 | 490 | 90 | N.D. | 50.4 | 94.3 | 299 | 14.4 | 16.0 | −0.49 | 5.2 | −6.3 |

In Example 10, the content of C was larger and the content of N was smaller than those of each Example of Experimental Example 1. In Example 10, the area proportion of the R₂T₁₄B main phase crystal grains and the coverage ratio were within the predetermined ranges, and good properties were obtained. Consequently, it was confirmed that, even if the hydrogen decarbonization treatment was not carried and the content of C was large, provided that the area proportion of the R₂T₁₄B main phase crystal grains and the coverage ratio of the R-T-B based permanent magnet were within the predetermined ranges, good properties can be obtained.

It was confirmed that the content of N in each of Examples 2 to 9 was 450 to 650 ppm in the same manner as in the content of N in Example 1.

1. An R-T-B based permanent magnet comprising R₂T₁₄B main phase crystal grains and a grain boundary, wherein
R is at least one rare-earth element, T is at least one iron group element comprising Fe or Fe and Co, and B is boron; and
the R₂T₁₄B main phase crystal grains have a coverage ratio of 50.0% or more, and an area proportion of the R₂T₁₄B main phase crystal grains is 92.0% or more in a cross section parallel to an orientation direction of the R-T-B based permanent magnet.

2. An R-T-B based permanent magnet according to claim 1, wherein
the R-T-B based permanent magnet further includes C; and
a content of C in the R-T-B based permanent magnet is 500 ppm or less.

3. An R-T-B based permanent magnet according to claim 1, wherein
the R-T-B based permanent magnet further includes O; and
a content of O in the R-T-B based permanent magnet is less than 900 ppm.

4. An R-T-B based permanent magnet according to claim 1, wherein
a residual magnetic flux density of the R-T-B based permanent magnet is 14.0 kG or more.

5. An R-T-B based permanent magnet according to claim 1, wherein
a content of R in the R-T-B based permanent magnet is 27.5 mass % or more and 31.5 mass % or less.

6. An R-T-B based permanent magnet comprising R₂T₁₄B main phase crystal grains, wherein
R is at least one rare-earth element, T is at least one iron group element comprising Fe or Fe and Co, and B is boron;
the R-T-B based permanent magnet further includes C; and
a content of C in the R₂T₁₄B main phase crystal grains is 300 ppm or less.

7. An R-T-B based permanent magnet according to claim 6, wherein
a degree of orientation of the R-T-B based permanent magnet is 94% or more, and the degree of orientation is defined by dividing a residual magnetic flux density by a saturation magnetic flux density in an orientation direction of the R-T-B based permanent magnet.

8. An R-T-B based permanent magnet according to claim 6, wherein
the content of C in the R-T-B based permanent magnet is 500 ppm or less.

9. An R-T-B based permanent magnet according to claim 6, wherein
the R-T-B based permanent magnet further includes H; and
a content of H in the R-T-B based permanent magnet is 50 ppm or less.

10. An R-T-B based permanent magnet according to claim 6, wherein
the R-T-B based permanent magnet further includes O; and
a content of O in the R-T-B based permanent magnet is less than 900 ppm.

11. An R-T-B based permanent magnet according to claim 6, wherein
a content of R in the R-T-B based permanent magnet is 27.5 mass % or more and 31.5 mass % or less.

12. An R-T-B based permanent magnet comprising R₂T₁₄B main phase crystal grains and a grain boundary, wherein
R is at least one rare-earth element, T is at least one iron group element comprising Fe or Fe and Co, and B is boron;
an area proportion of the R₂T₁₄B main phase crystal grains in the R-T-B based permanent magnet is 92.0% or more in a cross section parallel to an orientation direction of the R-T-B based permanent magnet;
the grain boundary includes an R-OCN phase;
a volume proportion of the R-OCN phase in the grain boundary is 34.0% or less;
the R-T-B based permanent magnet further includes O; and
a content of O in the R-T-B based permanent magnet is less than 900 ppm.

13. An R-T-B based permanent magnet according to claim 12, wherein
the R-T-B based permanent magnet further includes C; and
a content of C in the R-T-B based permanent magnet is 500 ppm or less.

14. An R-T-B based permanent magnet according to claim 12, wherein
a degree of orientation of the R-T-B based permanent magnet is 94% or more, and the degree of orientation is defined by dividing a residual magnetic flux density by a saturation magnetic flux density in the orientation direction of the R-T-B based permanent magnet.

15. An R-T-B based permanent magnet according to claim 12, wherein
a content of R in the R-T-B based permanent magnet is 27.5 mass % or more and 31.5 mass % or less.
